(19) United States
(12) Patent Application Publication
(10) Pub. No.: US 2010/0175128 A1
(43) Pub. Date: Jul. 8, 2010

(54) AUTHENTICATION INFORMATION MANAGEMENT APPARATUS, AUTHENTICATION INFORMATION MANAGEMENT PROGRAM AND METHOD THEREOF, AUTHENTICATION APPARATUS, AND AUTHENTICATION PROGRAM AND METHOD THEREOF

(75) Inventor: Takayuki Onozu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/709,984

(22) Filed: Feb. 22, 2010

Related U.S. Application Data
(63) Continuation of application No. PCT/JP2007/066414, filed on Aug. 24, 2007.

(51) Int. Cl. G06K 17/00; G06F 21/00

(52) U.S. Cl. 726/20

(57) ABSTRACT

An authentication information management apparatus manages authentication information for execution of authentication in an information processing device by utilizing a terminal device equipped with an IC card and a memory. The apparatus includes an identification information acquisition section that acquires identification information which is written in the IC card, and an authentication information setting section that retrieves stored authentication information corresponding to the identification information from the memory based on the identification information acquired by the identification information acquisition section, and sets up the IC card so that the retrieved authentication information is readable from the IC card.

### CROSS-REFERENCE TO RELATED APPLICATIONS

This application is a continuation application, filed under 35 U.S.C. §111(a), of PCT Application No. PCT/JP2007/066414, filed Aug. 24, 2007, the disclosure of which is herein incorporated in its entirety by reference.

### FIELD

The present invention relates to an authentication information management apparatus which stores plural pieces of authentication information in a memory and which writes authentication information into an IC card from the memory at the time of authentication and also relates to an authentication information management program and a method thereof, an authentication apparatus, and an authentication program and a method thereof.

### BACKGROUND

In the case where authentication is executed with an IC card, authentication information such as an ID/password etc. is read from an IC chip of the IC card through an IC card reader/writer, the authentication information is reported to an authentication management device or an application as an authentication object, and thereby authentication is conducted.

As the prior art related to the present invention, an authentication method for a portable electronic equipment using a contactless type IC card is known (for example, Japanese Laid-open Patent Publication No. 2006-113719). When a single IC card is used to authentication for plural objects, it is necessary to write plural pieces of authentication information into an IC chip.

### [Patent Document 1] Japanese Laid-open Patent Publication No. 2006-113719

However, an IC chip of an IC card is expensive because it is used for storing secure information, and a memory capacity of an IC chip of an IC card penetrating the market is not large. For this reason, with respect to the cost, there is a large problem in storing plural pieces of authentication information into an IC card.

### SUMMARY

According to the present invention, there is provided an authentication information apparatus which manages authentication information for execution of authentication in an information processing device by utilizing a terminal device equipped with an IC card and a memory, the apparatus including: an identification information acquisition section that acquires identification information which is written in the IC card; and an authentication information setting section that retrieves stored authentication information corresponding to the identification information from the memory based on the identification information acquired by the identification information acquisition section, and sets up the IC card so that the retrieved authentication information is readable from the IC card.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram depicting the entire configuration of a system having a mobile phone connected to business equipment through a reader/writer, according to an embodiment of the present invention;

FIG. 2 is a block diagram depicting the configuration of a mobile phone that includes an IC card and an internal memory according to the embodiment of the present invention;

FIG. 3 is a block diagram depicting the configuration of the IC card that includes an IC memory unit in the mobile phone;

FIG. 4 is a block diagram depicting the configuration of the internal memory of the mobile phone;

FIG. 5 is a block diagram depicting the configuration of the IC memory unit of the IC card;

FIG. 6 is a block diagram depicting the configuration of an authentication information management apparatus according to the embodiment of the present invention;

FIG. 7 is a block diagram depicting the configuration of a business equipment and a reader/writer according to the embodiment of the present invention;

FIG. 8 is a block diagram of the processing flow of a flag generating operation according to the reader/writer;

FIG. 9 is a block diagram of the processing flow of the input processing of a flag and an ID/password in the authentication information management apparatus;

FIG. 10 is a block diagram illustrating three phases of the processing flow of the authentication processing according to the embodiment of the present invention; and

FIG. 11 is a block diagram of the processing flow of the operation of an automatic start-up of the authentication information management apparatus.

### DESCRIPTION OF EMBODIMENT

An embodiment of the present invention is described below with reference to the accompanying drawings.

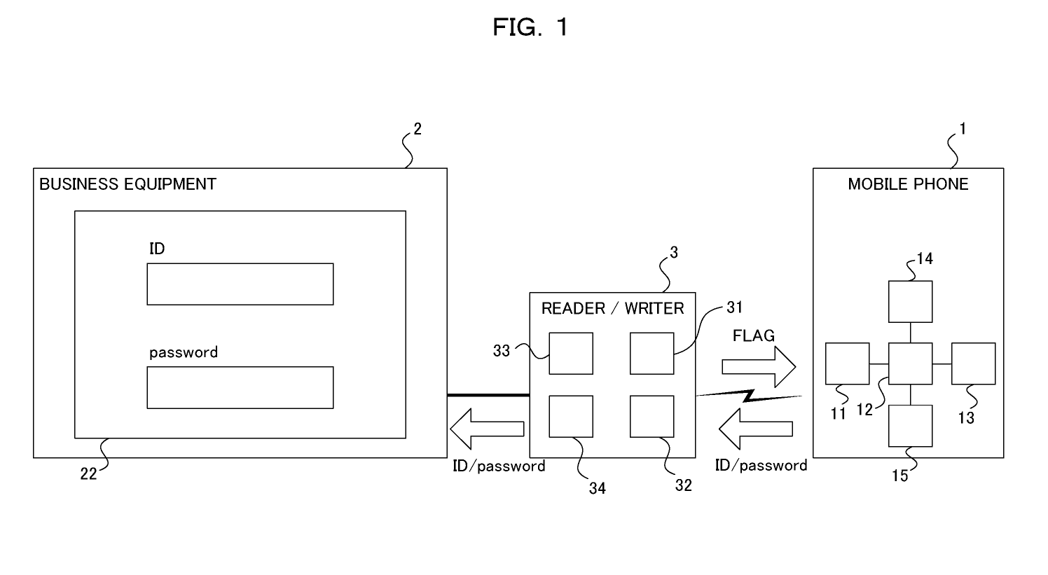

FIG. 1 is a block diagram depicting the configuration of an entire authentication system according to an embodiment of the present invention.

The authentication system includes a mobile phone 1 (which is a terminal device) on which a contactless type IC card that maintains authentication information is mounted, a business equipment 2 (which is an authentication device) for performing authentication, and a reader/writer 3 (which is an authentication device) for performing reading and writing authentication information with respect to the mobile phone 1. The mobile phone 1 maintains a flag (which is identification information) that is information used to identify the authenticated objects, and an ID/password (which is authentication information) that is information for authentication. The mobile phone 1 causes the reader/writer 3 to read the ID/password corresponding to the flag that is acquired from the reader/writer 3. The business equipment 2 acquires an ID/password from the reader/writer 3 so as to perform authentication.

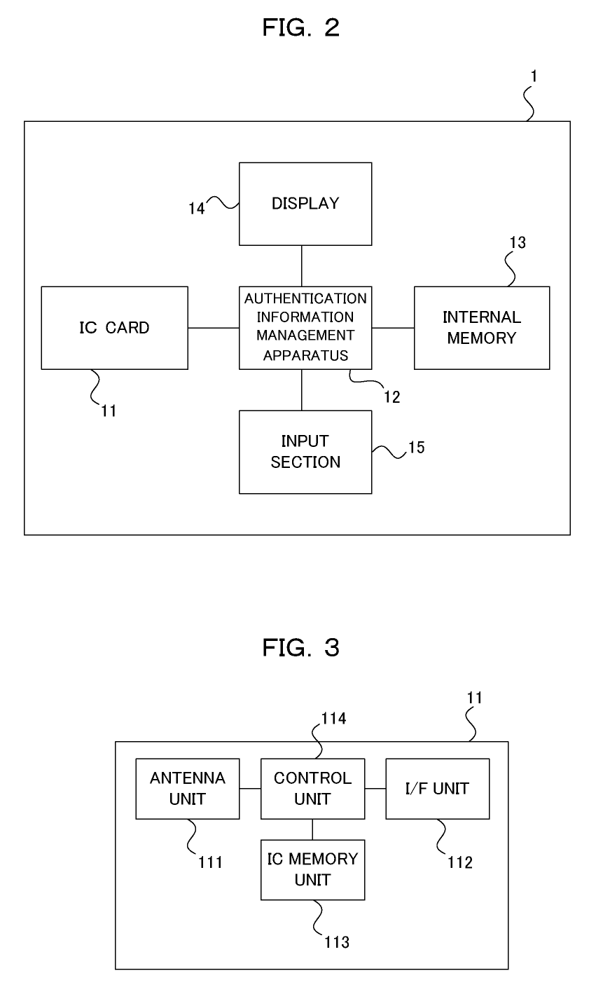

FIG. 2 is a block diagram depicting the configuration of the mobile phone according to the embodiment of the present invention.

The mobile phone 1 includes an IC card 11, an authentication information management apparatus 12, an internal memory 13, a display 14 and an input section 15. The input section 15 receives an input operation for the identification information and authentication information. The display 14 is used to display information when the identification information and authentication information are input through the input section 15. The IC card 11, the authentication information management apparatus 12, and the internal memory 13 are described below with reference to the accompanying drawings.

FIG. 3 is a block diagram depicting the configuration of the IC card in the mobile phone.

The IC card 11 includes an antenna unit 111, an I/F unit 112, an IC memory unit 113 and a control unit 114. The antenna unit 111 performs transmission/reception of information to/from the reader/writer 3, the I/F unit 112 performs transmission/reception of information to/from the authentication information management apparatus 12, the IC memory unit 113 stores information, and the control unit 114 controls the transmission/reception of information among the antenna unit 111, the I/F unit 112 and the IC memory unit 113.

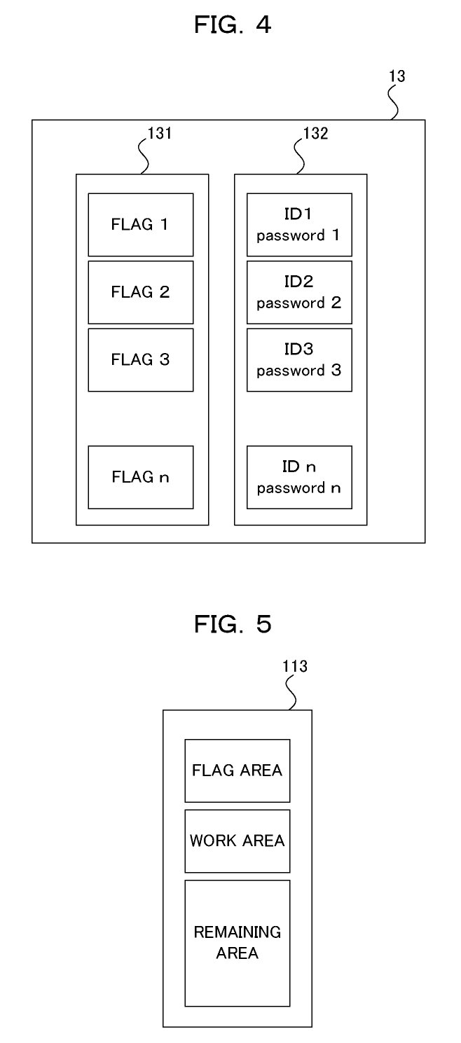

FIG. 4 is a block diagram depicting the configuration of the internal memory of the mobile phone.

The internal memory 13 includes an identification information storage unit 131 which stores the flag, and an authentication information storage unit 132 which stores the ID/password. The flag indicating a specified authenticated object, and the authentication information thereof, i.e. an ID/password, are stored in the internal memory 13 so that the flag corresponds to the ID/password. Moreover, the accesses to the identification information storage unit 131 and the authentication information storage unit 132 are carried out only by the memory processing section 123 of the authentication information management apparatus 12, described below.

FIG. 5 is a block diagram depicting the configuration of the IC memory unit of the IC card.

A flag area for temporarily storing the flag and a WORK area for temporarily storing an ID/password are defined within the IC memory unit 113 in the IC card 11. The remaining area which is an area in the IC memory unit 113 except the flag area and WORK area, is not used in the embodiment of the present invention, but may be used by other devices or with other programs.

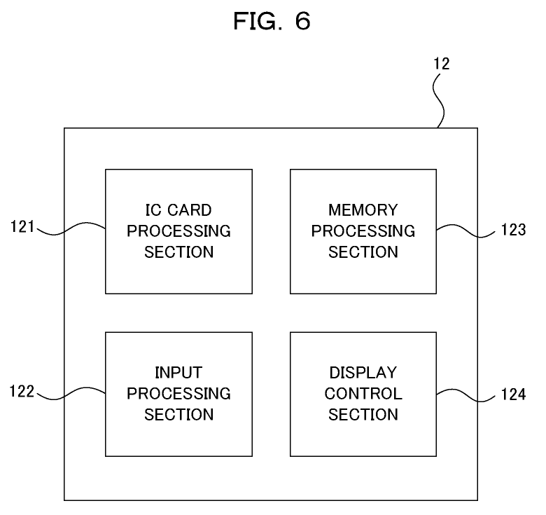

FIG. 6 is a block diagram indicating the configuration of the authentication information management apparatus according to the embodiment of the present invention.

The authentication information management apparatus 12 includes an IC card processing section 121 (identification information acquisition section, authentication information setting section), an input processing section 122, a memory processing section 123 (authentication information storage processing section), and a display control section 124.

The memory processing section 123 stores the flag and the ID/password corresponding to the flag into the internal memory 13 so that the flag corresponds to the ID/password in the internal memory 13. The memory processing section 123 may encrypt the flag and the ID/password and store them in the internal memory 13 so that the encryption ensures higher security. Furthermore, when the flag and the ID/password which are acquired from the internal memory 13 are encrypted, the memory processing section 123 decrypts the acquired flag and the ID/password.

The IC card processing section 121 causes the IC card 11 to acquire a flag. The IC card processing section 121 acquires an ID/password from the authentication information storage unit 132 of the internal memory 13 based on the flag which is acquired from the flag area of IC memory unit 113 of the IC card 11, and then causes the IC card 11 to store the acquired ID/password into the WORK area of the IC memory unit 113.

The input processing section 122 acquires the input information through the input section 15, and the display control section 124 instructs the display 14 to display the necessary information during information inputting.

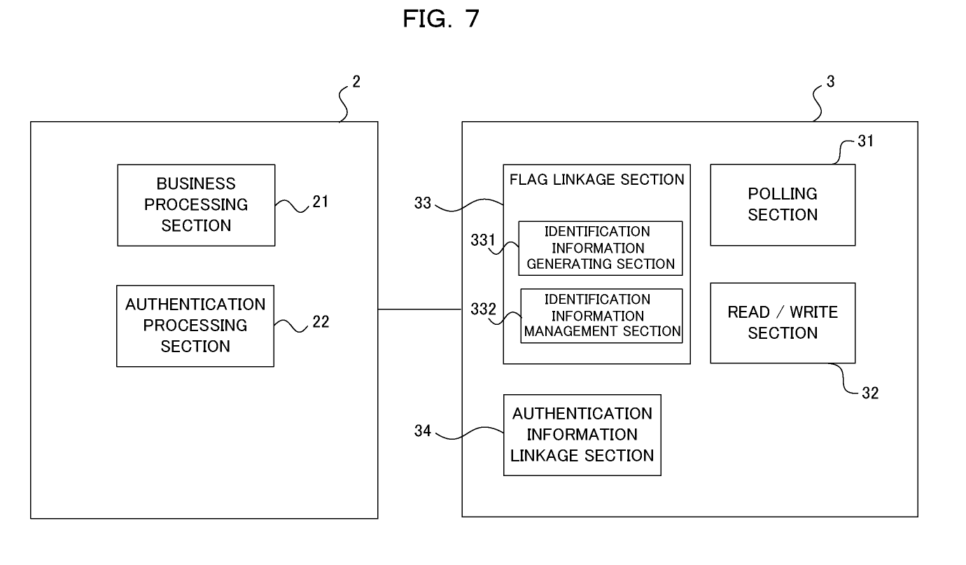

FIG. 7 is a block diagram indicating a configuration of the business equipment and the reader/writer according to the embodiment of the present invention. The business equipment is constructed from a personal computer in the embodiment of the present invention. The business equipment and the reader/writer are connected via a cable.

The business equipment 2 includes a business processing section 21 and an authentication processing section 22. The authentication processing section 22 is an application for carrying out authentication, executes authentication using the previously registered ID/password, and outputs the control ID which is the identification information indicating the authentication processing section 22 itself. The business processing section 21 is an application for carrying out predetermined works and may start up if the authentication processing section 22 completes the authentication.

The reader/writer 3 includes a polling section 31, a read/write section 32, a flag linkage section 33 (identification information management section, identification information generating section), and an authentication information linkage section 34.

The polling section 31 causes the read/write section 32 to detect the ID/password that is written into the WORK area of the IC memory unit 113 of the IC card 11 of the mobile phone 1. The read/write section 32 writes the flag into the flag area of the IC memory unit 113 and reads the ID/password from the WORK area. The read/write section 32 initializes the flag area and the WORK area of the IC memory unit 113. As a result of the initialization of the flag area and the WORK area, it is possible to protect the flag and the ID/password from leakage, thereby increasing security.

The flag linkage section 33 includes the identification information generating section 331 and the identification information management section 332. The identification information generating section 331 generates a flag for use of identification, on the basis of the control ID which is sent from the authentication processing section 22 (which is the authentication object) of the business equipment 2. The identification information management section 332 manages the flag and the authentication processing section 22 so that the flag corresponds to the authentication processing section 22. The authentication information linkage section 34 notifies the ID/password acquired by the read/write section 32 to the authentication processing section 22 of the business equipment 2.

The operation of the mobile phone, the business equipment and the reader/writer according to the embodiment of the present invention will be described below.

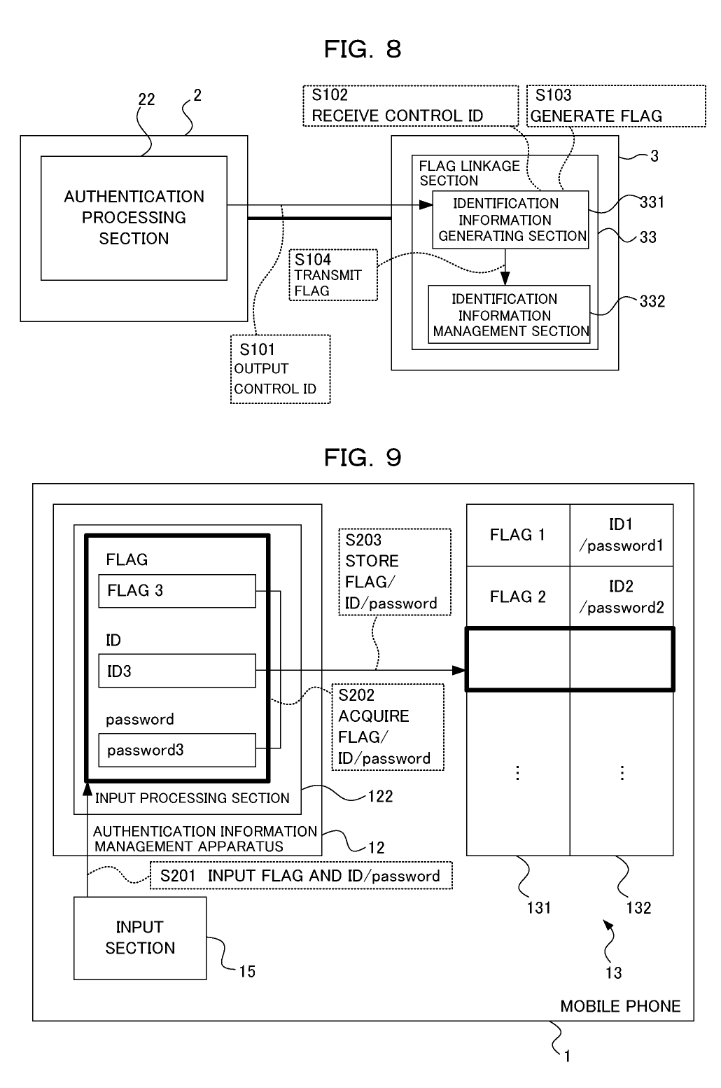

FIG. 8 is a flow processing diagram indicating a flag generating operation according to the reader/writer.

Firstly, at the time that the authentication processing section 22 of the business equipment 2 starts up, the authentication processing section 22 outputs a control ID that indicates itself as an inherent identification information, towards the flag linkage section 33 of the reader/writer 3 (S101), and the identification information generating section 331 of the flag linkage section 33 receives the control ID from the started authentication processing section 22 (S102). The identification information generating section 331 generates a flag as identification information based on the received control ID (S103), and transmits the flag to the identification information management section 332 (S104). The identification information management unit 332 records and manages the flag which is received from the identification information generating section 331, so that the flag corresponds to the control ID of the authentication processing section 22. According to these operations, the flag that is identification information indicating a specific authentication processing section 22 is generated and managed. Hereafter, it will make the reader/writer 3 transmit a flag that is generated in response to the starting-up of the authentication processing section 22. The flag linkage section 33 always monitors the control ID output from the authentication processing section 22, and only when a flag coincides with a control ID received at the generation of the flag, causes the reader/writer 3 to transmit the flag.

Note that, the flag may be generated with respect to the business processing section 21 which is a specific application corresponding to authentication processing section 22, or may be generated with respect to business equipment 2 which is a specific personal computer.

FIG. 9 is a flow processing indicating the input processing of a flag and the ID/password from the authentication information management apparatus.

At first, a flag 3 which is a specific flag used as authentication information, and an ID3/password3 which is an ID/password corresponding to flag 3 are input through the input section 15 of the mobile phone 1 (S201). The input processing section 122 of the authentication information management apparatus 12 acquires the input flag 3 and ID3/password3 (S202). With respect to the flag 3 and ID3/password3 acquired by the input processing section 122, the memory processing section 123 (FIG. 6) stores the flag 3 in the identification information storage unit 131 of the internal memory 13 of the mobile phone 1, and stores the ID3/password3 with the flag 3 corresponding to the ID3/password3 in the authentication information storage unit 132 (S203, acquiring and storing).

The storing the flag and the corresponding ID/password allows the authentication information management apparatus 12 to identify the ID3/password3 by using the specific flag 3 as an argument. Moreover, when the mobile phone 1 is held over the reader/writer 3 that transmits the flag during the input of ID/password, the IC card processing section 121 of the authentication information management apparatus 12 may acquire the flag from the IC card 11, thus the flag is input automatically.

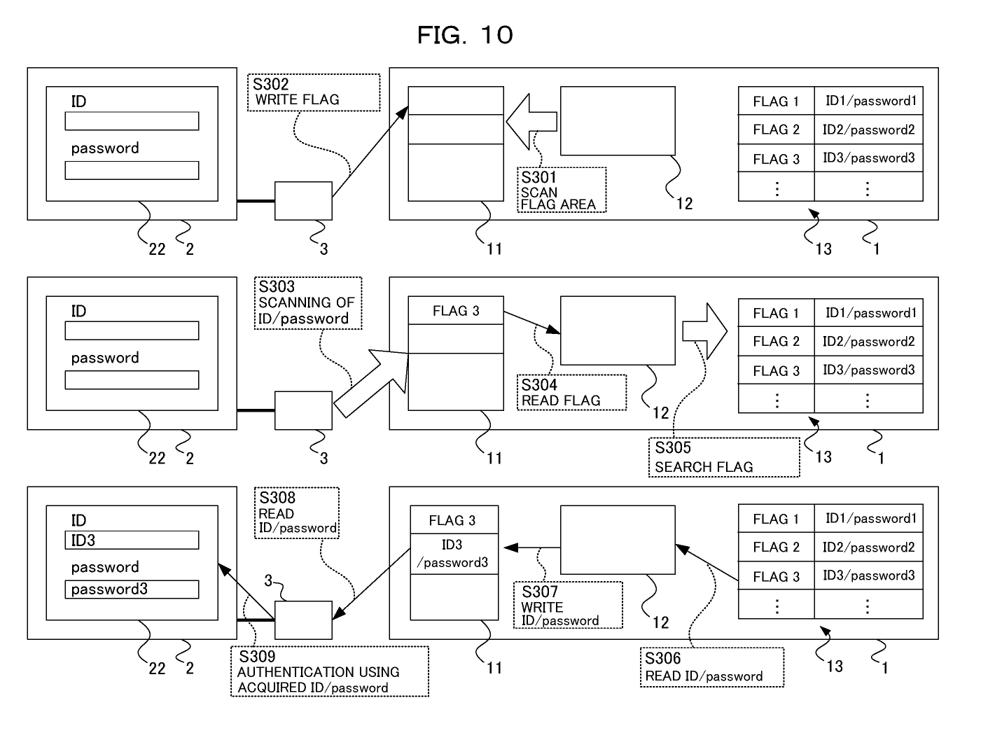

FIG. 10 is a processing flow indicating authentication processing according to the embodiment of the present invention. In FIG. 10, the authentication information management apparatus 12 has started up and the flag 3 which indicates the authentication processing section 22 has been generated.

In the beginning, the IC card processing section 121 of the authentication information management apparatus 12 continuously or periodically scans the flag area of the IC card 11 to determine whether or not a flag is written in the area (S301). The flag linkage section 33 of the reader/writer 3 confirms that the control ID output from the authentication processing section 22 coincides with the control ID acquired during the flag generation, and causes the read/write section 32 to write the flag 3 into the flag area (S302, writing).

Then the polling section 31 of the reader/writer 3 starts the scanning of ID/password on the WORK area of the IC card 11 (S303). The IC card processing section 121 of the authentication information management apparatus 12 reads the flag 3 from the flag area (S304, acquiring identification information) and searches for the flag 3 in the internal memory 13 (S305).

When the memory processing section 123 detects the flag 3 in the internal memory 13, the memory processing section 123 reads the ID3/password3 that is an ID/password corresponding to the flag 3 (S306) and then the IC card processing section 121 writes the ID3/password3 into the WORK area of the IC card 11 (S307, retrieving and setting up).

Then polling section 31 of the reader/writer 3, which had conducted the scanning of ID/password on the WORK area, detects the ID3/password3, and the read/write section 32 reads the written ID3/password3 from the WORK area (S308, reading). The authentication information linkage section 34 acquires the ID3/password3 from the read/write section 32 and informs of the ID3/password3 to the authentication processing section 22 of the business equipment 2. The authentication processing section 22 executes authentication using the ID3/password3 (S309, executing).

As described above, even though the mobile phone 1 contains an IC card 11 with a small amount of memory, multiple authentications can be automatically executed by managing the plural ID/passwords wherein each of the plural ID/passwords corresponds to one of the flags which indicates an equipment or an application, in the internal memory 13 of the mobile phone 1, and by writing an ID/password into the IC card according to the flag transmitted from the reader/writer 3.

Further, before the reader/writer 3 reads the ID/password from the IC card 11, a PIN authentication using the IC card 11 can be executed in order to obtain higher security. By holding the mobile phone 1 over the reader/writer 3 when the reader/writer 3 transmits a start up command, authentication information management apparatus 12 may automatically start up. The operation is described as follow.

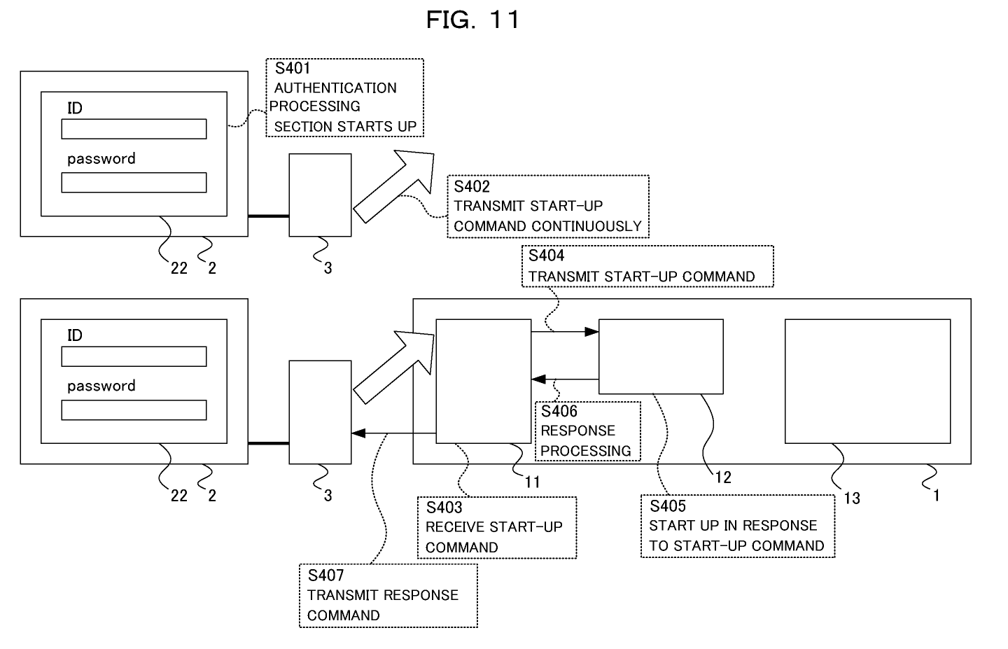

FIG. 11 is a processing flow diagram depicting the operation of automatic start-up of the authentication information management apparatus.

At first, when the authentication processing section 22 of the business equipment 2 starts up (S401), the flag linkage section 33 of the reader/writer 3 detects the authentication processing section 22, and causes the read/write section 32 to transmit continuously the start up command of authentication information management apparatus 12 of the mobile phone 1 (S402).

When the mobile phone 1 is held over the reader/writer 3 during the transmitting of a start up command, an antenna unit 111 of the IC card 11 of the mobile phone 1 receives the start up command (S403), then the received start up command is transmitted to the authentication information management apparatus 12 by the I/F unit 112 (S404).

In response to the start up command, the authentication information management apparatus 12 starts up (S405), and returns the response processing signal (S406). Moreover, even if the authentication information management apparatus 12 had started up before receiving the start up command, it still returns the response processing signal.

The control unit 114 of the IC card 11, which received the response processing signal through the I/F unit 112, interprets the response processing, and causes the antenna unit 111 to transmit a response command (S407). When the reader/writer 3 receives the response command, it executes authentication with the same operation of processing flow illustrated in FIG. 10.

According to the operation described above, when the mobile phone 1 is held over the reader/writer 3, the authentication information management apparatus 12 starts up and then the authentication can be executed.

In the embodiment of the present invention, although the terminal device maintaining authentication information is exemplified as the mobile phone 1 that includes the contactless type IC card, the terminal device may be constructed from a device which includes an internal memory 13 and the IC card 11 and may install the authentication information management apparatus 12 therein. The IC card may be a contact IC card.

Furthermore, in regard to the computer that forms the authentication information management apparatus 12 or the authentication device (the business equipment 2 and the reader/writer 3), it is possible to provide a program that execute the above-mentioned steps as authentication information management program or an authentication program. By storing the above program in a computer-readable storage medium, it is possible to allow the computer constituting the authentication information management apparatus 12 or the authentication device to execute the program. The computer-readable medium mentioned here includes: an internal storage device mounted in a computer, such as ROM or RAM, etc., a portable storage medium such as a CD-ROM, a flexible disk, a DVD disk, a magnet-optical disk, or an IC card etc., a database that holds a computer program, another computer and database thereof, and a transmission medium on a network line.

As described above, according to the present invention, by storing multiple authentication information in memory, writing the authentication information on the memory into an IC card during authenticating, it is possible to provide an authentication information management apparatus that can execute multiple authentications with only a single IC card resulting in less cost, authentication information management program along with its method, authentication device, authentication program along with its method.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An authentication information management apparatus which manages authentication information for execution of authentication in an information processing device by utilizing a terminal device equipped with an IC card and a memory, the apparatus comprising:
an identification information acquisition section that acquires identification information which is written in the IC card; and
an authentication information setting section that retrieves stored authentication information corresponding to the identification information from the memory based on the identification information acquired by the identification information acquisition section, and sets up the IC card so that the retrieved authentication information is readable from the IC card.

2. The authentication information management apparatus according to claim 1, further comprising
an authentication information storage processing section that acquires the identification information from the IC card, and stores the identification information and the authentication information with respect to the identification information into the memory so that the identification information corresponds to the authentication information.

3. The authentication information management apparatus according to claim 1, wherein the IC card includes:
an identification information storage unit that stores the identification information; and
an authentication information storage unit that stores authentication information corresponding to the identification information, and
the authentication information setting section retrieves authentication information corresponding to the identification information from the memory based on identification information stored in the identification information storage unit, and sets up the IC card so that the authentication information is readable from the IC card.

4. The authentication information management apparatus according to claim 1, wherein the terminal device is a mobile phone, and the IC card is a contactless IC card mounted on the mobile phone.

5. A computer-readable medium having recorded thereon an authentication information management program that causes a computer of a terminal device equipped with an IC card and a memory, to execute a process comprising:
acquiring identification information which is written in the IC card; and
retrieving stored authentication information corresponding to the identification information from the memory based on the identification information acquired by the acquiring and setting up the IC card so that the retrieved authentication information is readable from the IC card.

6. The computer-readable medium according to claim 5, wherein the program further causes the computer to execute acquiring the identification information from the IC card and storing the identification information and the authentication information with respect to the identification information into the memory so that the identification information corresponds to the authentication information.

7. The computer-readable medium according to claim 5, wherein the IC card includes:
an identification information storage unit that stores the identification information; and
an authentication information storage unit that stores authentication information corresponding to the identification information, and
the retrieving and setting up retrieves authentication information corresponding to the identification information from the memory based on identification information stored in the identification information storage unit, and sets up the IC card so that the authentication information is readable from the IC card.

8. An authentication information management method which manages authentication information by utilizing a computer of a terminal device, the authentication information being intended for execution of authentication in an information processing device by utilizing the terminal device equipped with an IC card and a memory, the method comprising:
acquiring identification information which is written in the IC card; and
retrieving stored authentication information corresponding to the identification information from the memory based on the identification information acquired by the acquiring and setting up the IC card so that the retrieved authentication information is readable from the IC card.

9. The authentication information management method according to claim 8, further comprising:
acquiring the identification information from the IC card and storing the identification information and the authentication information with respect to the identification information into the memory so that the identification information corresponds to the authentication information.

10. The authentication information management method according to claim 8, wherein the IC card includes:
an identification information storage unit that stores the identification information; and
an authentication information storage unit that stores authentication information corresponding to the identification information, and
the retrieving and setting up retrieves authentication information corresponding to the identification information from the memory based on identification information stored in the identification information storage unit, and sets up the IC card so that the authentication information is readable from the IC card.

11. An authentication apparatus which executes authentication by reading authentication information from an IC card, the apparatus comprising:
an identification information management section that defines correspondence between an authentication object related to authentication information and identification information, and manages the authentication object and the identification information;
a read/write section that writes the identification information managed by the identification information management section into the IC card, and reads authentication information corresponding to the identification information that is written in the IC card based on the writing; and
an authentication processing section that executes authentication based on the authentication information read by the read/write section.

12. The authentication apparatus according to claim 11, further comprising:
an identification information generating section that generates identification information to be managed by the identification information management section, with respect to the authentication object.

13. A computer-readable medium having recorded thereon an authentication program which causes a computer to execute authentication by reading authentication information from an IC card, the program causing the computer to execute a process comprising:
defining correspondence between an authentication object related to authentication information and identification information, and managing the authentication object and the identification information;
writing the identification information managed by the defining and managing into the IC card, and reading authentication information corresponding to the identification information that is written in the IC card based on the writing; and
executing authentication based on the authentication information read by the writing and reading.

14. An computer-readable medium according to claim 13, causing the computer to execute a process further comprising
generating identification information to be managed by the defining and managing, with respect to the authentication object.

15. An authentication method that causes computer to execute authentication by retrieving authentication information from IC card; the method comprising:
defining correspondence between an authentication object related to authentication information and identification information, and managing the authentication object and the identification information;
writing the identification information managed by the defining and managing into the IC card, and reading authentication information corresponding to the identification information that is written in the IC card based on the writing; and
executing authentication based on the authentication information read by the writing and reading.

16. An authentication method according to claim 15, further comprising
generating identification information to be managed by the defining and managing, with respect to the authentication object.

17. An authentication method which utilizes a terminal device equipped with an IC card and a memory so as to cause an information processing device to execute authentication, the method comprising:
in the information processing device, defining correspondence between an authentication object related to authentication information and identification information, and managing the authentication object and the identification information;
in the information processing device, writing the identification information corresponding to the authentication object into the IC card;
in the terminal device, acquiring the identification information written in the IC card;
in the terminal device, retrieving stored authentication information corresponding to the identification information from the memory based on the identification information acquired by the acquiring, and setting up the IC card so that the retrieved authentication information is readable from the IC card;
in the information processing device, reading the authentication information from the IC card; and
executing authentication by utilizing the authentication information read by the reading.

18. An authentication method according to claim 17, further comprising
generating identification information to be managed by the defining and managing, with respect to the authentication object.

19. An authentication method according to claim 17, wherein the terminal device is a mobile phone and the IC card is a contactless IC card which is mounted on the mobile phone.

20. An authentication method according to claim 17, wherein the writing and the reading are executed by a read/write device included in the information processing device.
